(19) United States
(12) Patent Application Publication
(10) Pub. No.: US 2018/0298875 A1
(43) Pub. Date: Oct. 18, 2018

(54) BUOYANCY-DRIVEN POWER GENERATION APPARATUS USING GRAVITY BODY

(71) Applicant: Min Shy JUNG, Gangneung-si (KR)

(72) Inventor: Min Shy JUNG, Gangneung-si (KR)

(73) Assignee: Min Shy JUNG, Gangneung-si, Gangwon-do (KR)

(21) Appl. No.: 15/768,111

(22) PCT Filed: Nov. 6, 2015
(86) PCT No.: PCT/KR2015/011900

§ 371 Date: Apr. 13, 2018

(30) Foreign Application Priority Data
Oct. 13, 2015 (KR) 10-2015-0142719

(51) Int. Cl. F03B 13/18; F03B 15/00; F16H 7/04

(52) U.S. Cl. CPC F03B 13/18; F03B 15/00; F05B 2260/505; F05B 2240/93; F16H 7/04

(57) ABSTRACT

The present invention relates to a buoyancy-driven power generation apparatus using a gravity body. To achieve this, according to the present invention, a rotary module is configured with at least one rotary body mounted on a rotary shaft, a latch provided between the rotary body and the rotary shaft such that the rotary body transmits power only in one direction, and a power transmission gear mounted on one end portion of the rotary shaft. A rope is mounted on the rotary body of the rotary module to make contact with the same to move up and down. A buoyant body hangs from one end portion of the rope, and a gravity body lighter in weight than the buoyant body hangs from the other end portion of the rope. A power gear is provided on one end portion of the rotary module so as to be engaged with the power transmission gear such that the rotating force of the power gear is transmitted to a generator. Accordingly, it is possible to effectively convert a movement of the surface of the sea into a vertical up and down motion of the buoyant body.

### TECHNICAL FIELD

The present invention relates to a buoyancy-driven power generation apparatus using a gravity body, and more particularly, to a buoyancy-driven power generation apparatus using a gravity body that has a rotation module having at least one rotational body on a shaft, wherein a rope is arranged to contact the rotational body and vertically move, wherein one side end of the rope is provided with a buoyant body and the opposite side end of the rope is provided with the gravity body whose weight is less than that of the buoyant body, such that power generation can be stably and persistently performed.

### BACKGROUND

In the past, thermal power generation using chemical energy of fossil fuels, hydroelectric power generation using potential energy of water in a dam, and nuclear power generation using nuclear fission of uranium have been widely used to generate electric power.

However, in recent years, as issues of exhaustion of resources and safety have arisen and eco-friendly values are increasingly emphasized, energy dependence on the three aforementioned power generation methods has been gradually decreasing, and a power generation system using solar power, tidal power, wave power, wind power, geothermal power or the like as infinite natural energy sources has increasingly drawn attention.

In addition, more than 70% of the surface of the earth is covered by the oceans. In particular, Korea is surrounded by the sea on three sides, and is thus a good environment to take advantage of the infinite energy of the sea. Accordingly, there is a growing interest in power generation apparatuses using waves in Korea.

For a power generation system using wave power, various problem-solving factors are required. Among these factors, providing a method of effectively collecting multidirectional movement of the sea surface and a method of efficiently generating and transmitting electric power using an easily installable structure or a previously installed structure is a major challenge.

Relevant prior art documents include Korean Patent No. 10-1510632 disclosing “Wave Power Generating Apparatus” (registered on Apr. 3, 2015) and Korea Patent Application Publication No. 10-2014-0093913 disclosing “Wave Power Generating Apparatus” (published on Jul. 29, 2014).

These prior art documents propose converting horizontal movement into rotational movement or vertical movement into rotational movement to produce electric energy.

However, with the aforementioned prior art documents, there is a difficulty in achieving efficient power generation from the sea surface, which moves in multiple directions. Further, due to the complicated structure of the power generation apparatus, members may suffer damage or failure during use of the power generation apparatus, and accordingly it is difficult to perform stable power generation.

Furthermore, issues, such as considerable costs or diseconomies, arise in constructing a structure for installing the power generation apparatus.

### DISCLOSURE

### Technical Problem

Therefore, the present invention has been made in view of the above problems, and it is one object of the present invention to provide a buoyancy-driven power generation apparatus using a gravity body that is capable of effectively converting movement of the sea surface into vertical movement, enhancing efficiency of management and repair with the simplified structure of the power generation apparatus, and facilitating installation of a structure for installing the power generation apparatus or employing a previously installed structure.

### Technical Solution

In accordance with one aspect of the present invention, provided is a buoyancy-driven power generation apparatus using a gravity body, the buoyancy-driven power generation apparatus including a rotation module 10 including at least one rotational body 12 provided on a shaft 11, a latch L arranged between the rotational body 12 and the shaft 11 to allow the rotational body 11 to transmit power only in one direction, and a power transmission gear provided at one side end of the shaft 11, a rope 20 mounted on the rotational body 12 of the rotation module 10 in a contacting manner to move up and down, a buoyant body 30 provided at one side end of the rope 20, a gravity body provided at an opposite side end of the rope 20 and having a weight less than a weight of the buoyant body 30, and a power gear 50 provided at one side end of the rotation module 10 to contact the power transmission gear 13 such that rotational force of the power gear 50 is transmitted to a generator 60.

In addition, the rotational body 12 may be a pinion gear, and the rope 20 may be arranged to move up and down while contacting a rack gear 21 formed on the rope 20.

In addition, the rope 20 may be moved up and down by being wound around the rotational body 12 by one or more turns.

In addition, the rotational body 12 may be provided with a spiral winding groove 12c, and the rope 20 may be placed in the winding groove 12c so as to be wound by one or more turns.

In addition, the rotation module 10 may include at least one first rotational body 12a and at least one second rotational body 12b arranged at positions corresponding to each other on a pair of a first shaft 11a and a second shaft 11b arranged in parallel, respectively, wherein the latch L may be provided between each of the first and second rotational bodies 12a and 12b and a corresponding one of the first and second shafts 11a and 11b such that the first and second rotational bodies 12a and 12b transmit power only in single directions different from each other, wherein one-side ends of the first and second shafts 11a and 11b may be provided with a first power transmission gear 13a and a second power transmission gear 13b, respectively.

In addition, the power gear 50 may have a ring shape and include an inner gear 51 formed on an inner circumferential surface thereof and an outer gear 52 formed on an outer circumferential surface thereof, the power gear being arranged to contact the first and second power transmission gears 13a and 13b.

In addition, the buoyant body 30 may be provided with a guide hole 31 to guide up and down movements of the rope 20.

In addition, the buoyant body 30 may include a column portion 30a in a cylindrical shape or a polygonal prism shape and a horn portion 30b formed in a conical shape or a polygonal pyramid shape 30b under the column portion 30a.

In addition, the buoyant body 30 may be provided with a fluid inlet 30c and a fluid outlet 30d to allow introduction or discharge of air or seawater.

In addition, the buoyant body 30 may be formed in a hollow shape, and an FRT coating layer 32 may be formed on an inside thereof to prevent corrosion by salt water.

In addition, an upper portion and a lower portion of the gravity body 40 may be provided with an inclined surface 40a or a curved surface 40b to reduce frictional resistance.

In addition, the gravity body 40 may be provided with a weight portion 40e so as to form a hollow portion, and be provided with a fluid inlet 40c and a fluid outlet 40d to allow air or seawater to be introduced into or discharged from the hollow portion.

In addition, the gravity body 40 may be provided with a plurality of weight pendulum insertion grooves 43 allowing a weight pendulum 44 to be inserted thereinto, and a weight pendulum cover 45 may be coupled to a top of the weight pendulum insertion grooves 43.

In addition, the rotation module 10 may be mounted on a structure 70, wherein at least one shaft fixing portion 71 having a bearing 71a on an inner circumferential surface thereof may be formed in the structure 70 such that the shaft 11 of the rotation module 10 contacts the bearing 71a through the shaft fixing portion 71.

In addition, the structure 70 may be provided with a rope guide portion 72 to guide movement of the rope 20.

The buoyancy-driven power generation apparatus may further include a weight transmission gear 80 configured to integrally rotate with the power gear 50, wherein the weight transmission gear 80 may be provided with a spur gear 81 to transmit power to a power generation gear 61 of the generator 60.

In addition, the weight transmission mechanism 80 may include a speed sensor 82 and a brake pad 83 to maintain a rotational speed within a certain range.

In addition, the rotation module 10 may include a current supply line 91 or a heat-wire 92 to receive current or heat from the generator 60.

### Advantageous Effects

For the buoyancy-driven power generation apparatus using a gravity body according to the present invention, one side end of a rope is provided with a buoyant body and the opposite side end of the rope is provided with the gravity body whose weight is less than that of the buoyant body. Accordingly, the buoyancy-driven power generation apparatus may effectively convert movement of the sea surface into vertical movement of the buoyant body.

In addition, as the rope is arranged to contact the rotational body of the rotation module and vertically move, the structure of the power generation apparatus may be simplified, and thus efficiency of management and repair may be enhanced.

In addition, the structure for installing the power generation apparatus may be easily mounted and installed, or a previously installed structure may be used.

### DESCRIPTION OF DRAWINGS

FIG. 1 is a perspective view showing a buoyancy-driven power generation apparatus using a gravity body according to an embodiment of the present invention.

FIG. 2 is a perspective view showing a buoyancy-driven power generation apparatus using a gravity body according to another embodiment of the present invention.

FIG. 3 is a front view illustrating operation of the buoyancy-driven power generation apparatus using the gravity body of the present invention.

FIG. 4 is a cross-sectional view of a rope and a rotation module according to an embodiment of the present invention.

FIG. 5 is a cross-sectional view of a rope and a rotation module according to another embodiment of the present invention.

FIG. 6 is a perspective view showing a power gear according to an embodiment of the present invention;

FIG. 7 is a conceptual diagram illustrating a power gear according to another embodiment of the present invention.

FIG. 8 is a side view showing a gravity transmission gear according to an embodiment of the present invention.

FIG. 9 is a cross-sectional view showing a buoyant body according to an embodiment of the present invention.

FIG. 10 is a cross-sectional view of a weight body according to various embodiments of the present invention.

FIG. 11 is a conceptual diagram illustrating a current supply line and a heating line according to an embodiment of the present invention.

### BEST MODE

Hereinafter, preferred embodiments of the present invention will be described in detail with reference to the accompanying drawings.

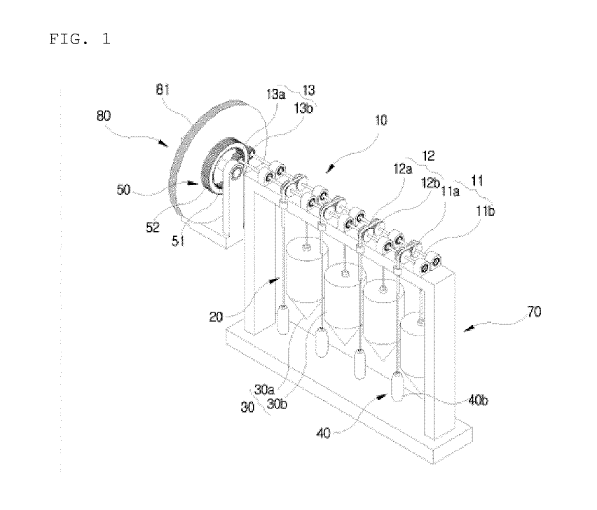

FIG. 1 is a perspective view showing a buoyancy-driven power generation apparatus using a gravity body according to an embodiment of the present invention. The buoyancy-driven power generation apparatus includes a rotation module 10, a rope 20 arranged on the rotation module 10, a buoyant body 30 and a gravity body 40, which are provided to both ends of the rope 20, a power gear 50 for receiving transmitted rotational force of the rotation module 10, and a generator 60 for generating power based on the rotational force.

Specifically, the rotation module 10 is configured to convert vertical movement of the rope 20 into rotational movement to transmit rotational force to the power gear 50, and is provided with at least one rotational body 12 on a shaft 11. The rotational body 12 is provided with a latch L, which is between the rotational body and the shaft 11, and is thus allowed to transmit power only in one direction. A power transmission gear 13 is provided at one side end of the shaft 11.

The shaft 11 includes a pair of first and second shafts 11a and 11b arranged in parallel, which include at least one first rotational body 12a and at least one second rotational body 12b at positions corresponding to each other. One-side ends of the first and second shafts 11a and 11b may be provided with first and second power transmission gears 13a and 13b.

The first and second rotational bodies 12a and 12b of the rotation module 10 are provided with a latch L arranged between the rotational bodies and the first and second shafts 11a and 11b, and thus may transmit power only in single directions different from each other.

That is, when a plurality of first rotational bodies 12a and second rotational bodies 12b is provided, the first and second rotational bodies 12a and 12b are caused to make different rotational movements by the independent vertical movements performed by the respective ropes 20. Thus, the first and second rotational bodies 12a and 12b may be provided with the latch L to independently transmit rotational force to the first and second shafts 11a and 11b.

The first and second power transmission gears 13a and 13b transmit the rotational force of the shafts 11a and 11b to the power gear 50, which will be described later.

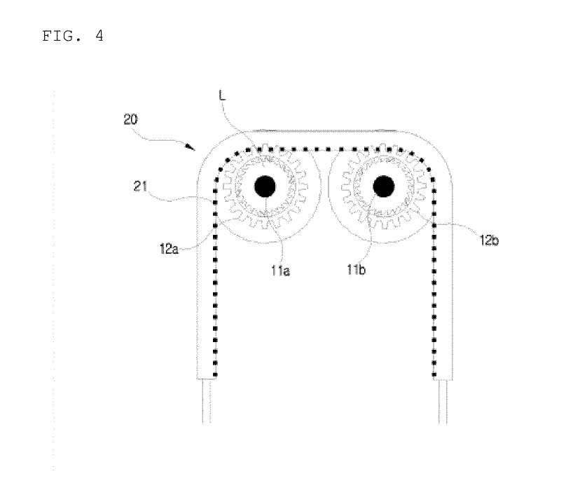

As shown in FIG. 4, the rotational body 12 may be a pinion gear, and the rope 20 may be arranged thereon such that a rack gear formed on the rope 20 contacts the pinion gear, and thus can move up and down. When the first and second rotational bodies 12a and 12b are configured as pinion gears, the rope 20 is arranged on the first and second rotational bodies 12a and 12b of the rotation module 10 to move up and down while the rack gear 21 formed on the rope 20 contacts the rotational bodies. One side end of the rope 20 is provided with a buoyant body 30 and the opposite side end thereof is provided with a gravity body 40 whose weight is less than that of the buoyant body 30.

The rack gear 21 provided to the rope 20 can be replaced by a chain. If the chain can transmit the vertical movement of the rope 20 to the rotation module 10, this configuration should be understood as being within the scope of the present invention since it can be easily achieved by those skilled in the art by making changes to the present invention.

As shown in FIG. 5, the rope 20 may be moved up and down by being wound around the rotational body 12 by one or more turns. Here, the rotational body 12 may include the first and second rotational bodies 12a and 12b to induce rotation in two directions, and vertical movement may be converted into rotational movement by friction generated between the rope 20 and the rotational body 12.

Here, the rotational body 12 may be provided with a spiral winding groove 12c, and the rope 20 may be arranged in the winding groove 12c so as to be wound around the rotational body by one or more turns.

Thereby, the rope 20 may be prevented from being separated from the rotational body 12, and power may be transmitted more effectively.

The buoyant body 30 performs vertical movement according to movement of the sea surface, and transmits the vertical movement of the rope 20 to rotational movement of the first and second rotational bodies 12a and 12b.

In this operation, the buoyant body 30 is guided by the gravity body 40 provided at the opposite end of the rope so as to perform effective vertical movement, despite multidirectional movement of the sea surface. Specifically, the gravity body 40 applies a certain tension to the rope 20 to prevent lateral movement of the buoyant body 30.

A guide hole 31 may be formed in the buoyant body 30 to guide the vertical movement of the rope 20.

That is, when a certain portion of the surface area of the buoyant body 30 is secured, the guide hole 31 formed in the buoyant body 30 may be fabricated so as to be penetrated by the rope 20 such that the buoyant body 30 can effectively perform vertical movement.

The buoyant body 30 may be formed in various shapes such as a spherical shape, a planar shape, a column shape, an inverted pyramid shape, and a conical shape. However, as shown in FIG. 7, the buoyant body preferably includes a column portion 30a in a cylindrical shape or a polygonal prism shape corresponding to the height H of a wave and a horn portion 30b formed in a conical shape or a polygonal pyramid shape under the column portion.

That is, the column portion 30a effectively secures buoyant force against the wave and the horn portion 30b prevents interference between the neighboring buoyant bodies 30.

In addition, the buoyant body 30 may be provided with a fluid inlet 30c and a fluid outlet 30d to allow introduction or discharge of air, seawater, or the like.

In adjusting buoyancy in relation to the gravity body 40, which will be described later, the buoyant body 30 may increase buoyancy by allowing air to be introduced thereinto and reduce buoyancy by allowing seawater to be introduced thereinto. That is, buoyancy can be controlled by introducing or discharging air or seawater using the fluid inlet 30c and the fluid outlet 30d.

Accordingly, the buoyant body 30 may be formed in a hollow shape to allow a fluid to be introduced thereinto, and a fiberglass reinforced plastic (FRP) coating layer 32 may be formed on the inside thereof to prevent corrosion by salt water.

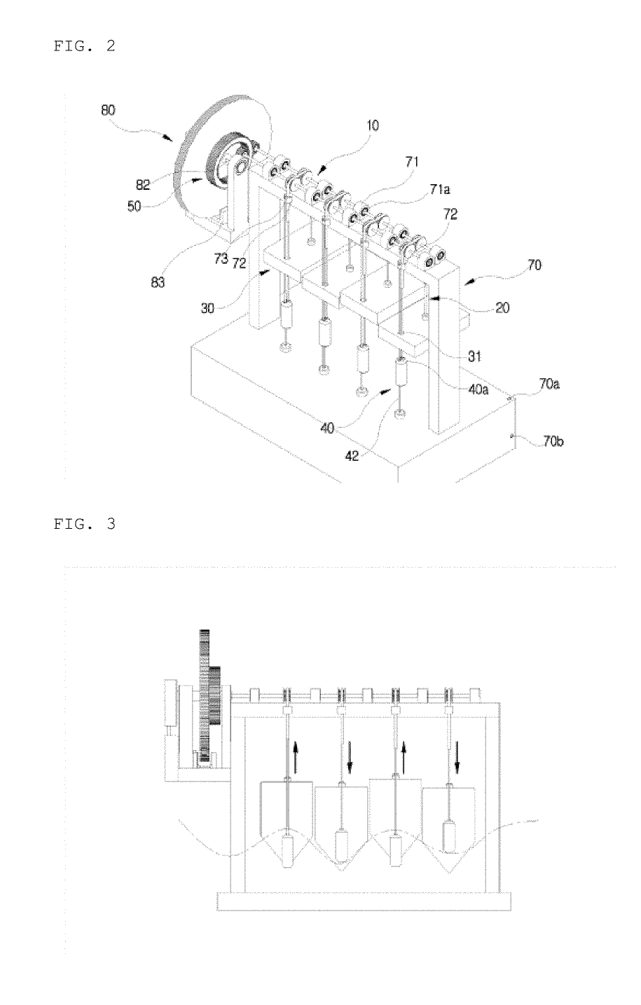

As shown in FIG. 2, a slide hole 41 may be formed in the gravity body 40 and a slide bar 42 may be arranged under the gravity body 40 so as to be inserted into the slide hole 41. Thus, the slide bar 42 may guide vertical movement of the gravity body 40 as it is inserted into the slide hole 41 of the gravity body 40.

The gravity body 40 applies a certain tension to the rope 20 to control the buoyant body 30 so as not to move laterally. However, when the gravity body 40 is moved due to a strong tidal current, vertical movement of the buoyant body 30 cannot be effectively guided. Therefore, the gravity body 40 may be guided to move up and down by providing the slide hole 41 in the gravity body 40 and causing the slide bar 42 to move along the slide hole 41.

In addition, if the gravity body 40 is brought into contact with the bottom surface, the base may cave in, thereby deteriorating stability of the structure. Accordingly, the gravity body 40 may be arranged not to directly contact the bottom surface.

In this regard, the slide bar 42 may be arranged in water in various ways, and may be fixed using various means such as a rope, a pillar, and a bottom plate.

The gravity body 40 may be arranged in water or may be arranged above the ground.

In addition, as shown in FIGS. 1 and 2, an inclined surface 40a or a curved surface 40b may be formed on the upper and lower portions of the gravity body 40. When the gravity body 40 moves up and down, it may laterally move due to underwater resistance. Thus, the inclined surface 40a or the curved surface 40b is preferably formed to ensure effective movement of the gravity body 40 while reducing the resistance through the shape of the gravity body 40.

As shown in FIG. 10, the gravity body 40 may be provided with a weight portion 40e such that a hollow portion is formed therein, and a fluid inlet 40c and a fluid outlet 40d may be formed in the hollow portion to allow air or seawater to be introduced into or discharged from the hollow portion.

Accordingly, in controlling gravity in relation to the buoyant body 30, the gravity body 40 may reduce gravity by allowing air to be introduced thereinto or reduce buoyancy by allowing seawater to be introduced thereinto. That is, gravity can be controlled by introducing or discharging air or seawater using the fluid inlet 40c and the fluid outlet 40d.

The gravity body 40 may be provided with a plurality of weight pendulum insertion grooves 43 allowing a weight pendulum 44 to be inserted thereinto, and a weight pendulum cover 45 may be coupled to the top of the weight pendulum insertion grooves 43.

Here, the weight pendulum insertion grooves 43 are preferably arranged in an annular shape to achieve weight balance, and gravity may be controlled by adjusting the number of weight pendulums 44. It is also possible to provide a plurality of weight pendulums 44 so as to be inserted into one weight pendulum insertion groove 43.

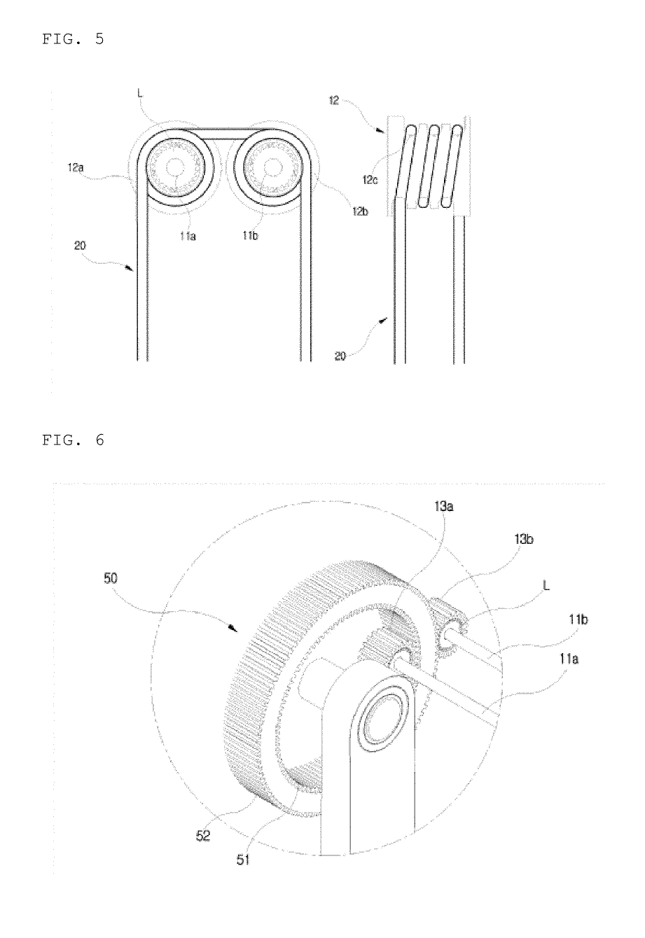

As shown in FIG. 6, a ring-shaped power gear 50 having an inner gear 51 formed on the inner circumferential surface thereof and an outer gear 52 formed on the outer circumferential surface thereof may be arranged at one side end of the rotation module 10 so as to contact the first and second power transmission gears 13a and 13b. Thereby, the rotational force of the power gear 50 is transmitted to the generator 60.

The first and second power transmission gears 13a and 13b, which are rotated in different directions, contact the inner and outer gears 51 and 52 formed on the inner and outer circumferential surfaces of the power gear 50, such that the power gear 50 continuously rotates only in one direction.

In another embodiment, as shown in FIG. 7, a belt 53 may be arranged on the power gear 50 in a contacting manner. The first power transmission gear 13a may be arranged on one surface of the belt 53 in a contacting manner, and the second power transmission gear 13b may be arranged on the opposite surface of the belt 53 in a contacting manner.

The belt 53 is formed to have gear teeth formed on both surfaces thereof or is formed in the shape of a chain, such that the first and second power transmission gears 13a and 13b contact both surfaces of the belt. Thereby, the power gear 50 is caused to continuously rotate only in one direction despite the rotational directions of the first and second power transmission gears 13a and 13b.

That is, the rotation module 10 of the present invention can convert both up and down vertical movements of the buoyant body 30 into rotational movement using the rope 20, thereby increasing power generation efficiency.

As shown in FIG. 2, the rotation module 10 may be mounted on the structure 70 and at least one shaft fixing portion 71 provided with a bearing 71a may be formed on the inner periphery of the structure 70. Thus, the first and second shafts 11a and 11b of the rotation module 10 may be arranged to contact the bearing 71a through the shaft fixing portion 71.

The structure 70 is not subject to any restriction so long as the rotation module 10 can be mounted thereon. The structure 70 may be a frame or a beam-shaped RC frame, or may be a coastal structure such as a breakwater.

For example, the structure 70 may be formed so as to penetrate a coastal structure such as a breakwater, and the rotation module 10 may be provided at both ends of the structure 70 to allow the rope 20 to pass through the structure 70 of the breakwater. The buoyant body 30 may be provided at one side end of the rope 20 and the gravity body 40 may be provided at the opposite side end of the rope, such that the buoyant body 30 and the gravity body 40 can perform vertical movement with the breakwater placed therebetween.

In this case, the gravity body 40 may be arranged in the water or may be arranged above the ground.

The shaft fixing portion 71, which serves to couple the structure 70 and the rotation module 10, may be provided with the bearing 71a on the inner circumferential surface thereof such that the first and second shafts 11a and 11b can rotate effectively.

The structure 70 may be provided with a rope guide portion 72 to guide vertical movement of the rope 20. As the rope 20 passes through the rope guide portion 72, the vertical movement may be more effectively guided.

In addition, the structure 70 may be provided with a bar fixing portion 73 to fix the slide bar 42.

By forming the slide hole 41 in the gravity body 40 and causing the slide bar 42 to move along the slide hole 41 as described above, the gravity body 40 may be guided to move up and down.

At this time, if the slide bar 42 is displaced, the slide bar 42 cannot function to guide the gravity body 40. The slide bar 42 may be maintained in a certain position by the bar fixing portion 73.

In addition, the structure 70 may be provided with a fluid inlet 70a and a fluid outlet 70b to allow introduction or discharge of air, seawater, or the like.

The structure 70 may increase buoyancy by allowing air to be introduced thereinto and reduce buoyancy by allowing seawater to be introduced thereinto. That is, by controlling buoyancy by introducing or discharging air or seawater using the fluid inlet 70a and the fluid outlet 70b, the structure 70 may be placed in water or lifted up out of water.

In addition, a photovoltaic module panel may be provided at the top of the structure 70 to perform additional power generation.

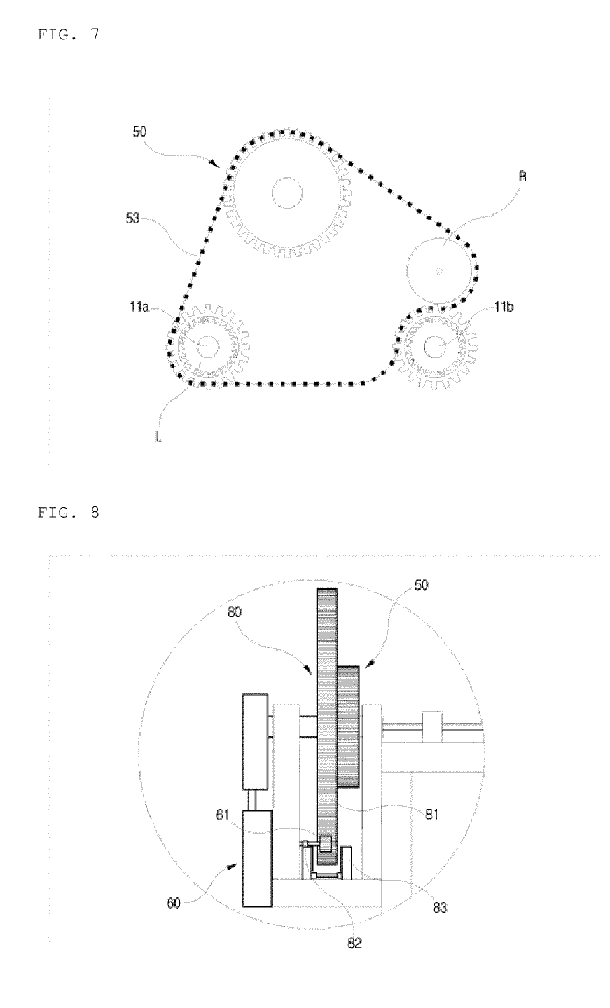

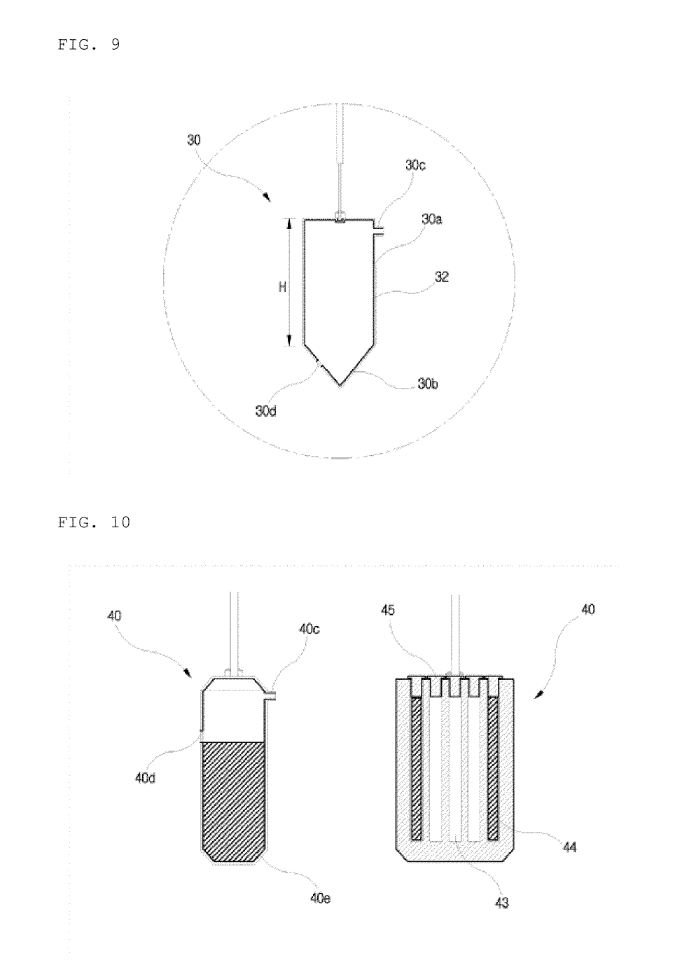

As shown in FIG. 8, a weight transmission gear 80 may be provided so as to rotate integrally with the power gear 50. The weight transmission gear 80 may be provided with a spur gear 81 to transmit power to a power generation gear 61 of the generator 60.

The weight transmission gear 80 changes the rotational speed of the power generation gear 61 and is further formed as a gravity body such that a constant rotational force can be transmitted to the power generation gear 61 by inertia.

Here, the weight transmission gear 80 may include a speed sensor 82 and a brake pad 83 to maintain the rotational speed within a predetermined range. That is, when the speed of the weight transmission gear 80 measured by the speed sensor 82 is relatively high, the speed can be adjusted by operating the brake pad.

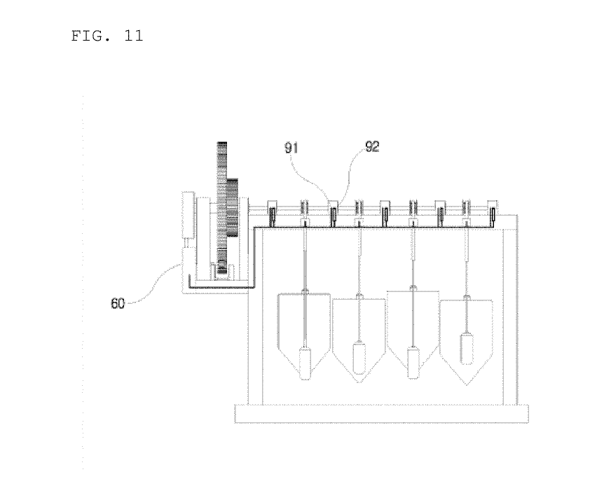

As shown in FIG. 11, the rotation module 10 may include a current supply line 91 or a heat-wire 92 to receive current or heat from the generator 60.

Thereby, oxidation of various metallic parts such as the shaft 11 and the rotational body 20 of the rotation module 10 may be prevented to secure durability. In addition, the current supply line 91 or the heat-wire 92 is preferably provided inside the structure 70 to use the electric power transmitted from the generator 60.

The buoyancy-driven power generation apparatus using a gravity body according to the present invention described above is not limited to the above-described embodiments, and various modifications and changes can be made thereto without departing from the spirit and scope of the present invention. Such modifications and changes should be regarded as within the scope of the appended claims.

1. A buoyancy-driven power generation apparatus using a gravity body, the buoyancy-driven power generation apparatus comprising:
a rotation module (10) comprising at least one rotational body (12) provided on a shaft (11), a latch (L) arranged between the rotational body (12) and the shaft (11) to allow the rotational body (12) to transmit power only in one direction, and a power transmission gear (13) provided at one side end of the shaft (11);
a rope (20) mounted on the rotational body (12) of the rotation module (10) in a contacting manner to move up and down;
a buoyant body (30) provided at one side end of the rope (20);
a gravity body (40) provided at an opposite side end of the rope (20) and having a weight less than a weight of the buoyant body (30); and
a power gear (50) provided at one side end of the rotation module (10) to contact the power transmission gear (13) such that rotational force of the power gear (50) is transmitted to a generator (60).

2. The buoyancy-driven power generation apparatus using a gravity body according to claim 1, wherein the rotational body (12) is a pinion gear, and the rope (20) is arranged to move up and down while contacting a rack gear (21) formed on the rope (20).

3. The buoyancy-driven power generation apparatus using a gravity body according to claim 1, wherein the rope (20) is moved up and down by being wound around the rotational body (12) by one or more turns.

4. The buoyancy-driven power generation apparatus using a gravity body according to claim 3, wherein the rotational body (12) is provided with a spiral winding groove (12c), and the rope 20 is placed in the winding groove (12c) so as to be wound by one or more turns.

5. The buoyancy-driven power generation apparatus using a gravity body according to claim 1, wherein the rotation module (10) comprises at least one first rotational body (12a) and at least one second rotational body (12b) arranged at positions corresponding to each other on a pair of a first shaft (11a) and a second shaft (11b) arranged in parallel, respectively,
wherein the latch L is provided between each of the first and second rotational bodies (12a) and (12b) and a corresponding one of the first and second shafts (11a) and (11b) such that the first and second rotational bodies (12a) and (12b) transmit power only in single directions different from each other,
wherein one-side ends of the first and second shafts (11a) and (11b) are provided with a first power transmission gear (13a) and a second power transmission gear (13b), respectively.

6. The buoyancy-driven power generation apparatus using a gravity body according to claim 5, wherein the power gear (50) has a ring shape and comprises an inner gear (51) formed on an inner circumferential surface thereof and an outer gear (52) formed on an outer circumferential surface thereof, the power gear (50) being arranged to contact the first and second power transmission gears (13a) and (13b).

7. The buoyancy-driven power generation apparatus using a gravity body according to claim 1, wherein the buoyant body (30) is provided with a guide hole (31) to guide up and down movements of the rope (20).

8. The buoyancy-driven power generation apparatus using a gravity body according to claim 1, wherein the buoyant body (30) comprises a column portion (30a) in a cylindrical shape or a polygonal prism shape and a horn portion 30b formed in a conical shape or a polygonal pyramid shape (30b) under the column portion (30a).

9. The buoyancy-driven power generation apparatus using a gravity body according to claim 1, wherein the buoyant body (30) is provided with a fluid inlet (30c) and a fluid outlet (30d) to allow introduction or discharge of air or seawater.

10. The buoyancy-driven power generation apparatus using a gravity body according to claim 9, wherein the buoyant body (30) is formed in a hollow shape, and an FRT coating layer (32) is formed on an inside thereof to prevent corrosion by salt water.

11. The buoyancy-driven power generation apparatus using a gravity body according to claim 1, wherein an upper portion and a lower portion of the gravity body (40) are provided with an inclined surface (40a) or a curved surface (40b) to reduce frictional resistance.

12. The buoyancy-driven power generation apparatus using a gravity body according to claim 1, wherein the gravity body (40) is provided with a weight portion (40e) so as to form a hollow portion, and is provided with a fluid inlet (40c) and a fluid outlet (40d) to allow air or seawater to be introduced into or discharged from the hollow portion.

13. The buoyancy-driven power generation apparatus using a gravity body according to claim 1, wherein the gravity body (40) is provided with a plurality of weight pendulum insertion grooves (43) allowing a weight pendulum (44) to be inserted thereinto, and a weight pendulum cover (45) is coupled to a top of the weight pendulum insertion grooves (43).

14. The buoyancy-driven power generation apparatus using a gravity body according to claim 1, wherein the rotation module (10) is mounted on a structure (70),
wherein at least one shaft fixing portion (71) having a bearing (71a) on an inner circumferential surface thereof is formed in the structure (70) such that the shaft (11) of the rotation module (10) contacts the bearing (71a) through the shaft fixing portion (71).

15. The buoyancy-driven power generation apparatus using a gravity body according to claim 14, wherein the structure (70) is provided with a rope guide portion (72) to guide movement of the rope (20).

16. The buoyancy-driven power generation apparatus using a gravity body according to claim 1, further comprising a weight transmission gear (80) configured to integrally rotate with the power gear (50),
wherein the weight transmission gear (80) is provided with a spur gear (81) to transmit power to a power generation gear (61) of the generator (60).

17. The buoyancy-driven power generation apparatus using a gravity body according to claim 16, wherein the weight transmission mechanism (80) comprises a speed sensor (82) and a brake pad (83) to maintain a rotational speed within a certain range.

18. The buoyancy-driven power generation apparatus using a gravity body according to claim 1, wherein the rotation module (10) comprises a current supply line (91) or a heat-wire (92) to receive current or heat from the generator (60).
